(19) United States
(12) Patent Application Publication
(10) Pub. No.: US 2015/0175873 A1
(43) Pub. Date: Jun. 25, 2015

(54) OIL RECOVERY PROCESS, SYSTEM, AND COMPOSITION

(71) Applicant: SHELL OIL COMPANY, Houston, TX (US)

(72) Inventors: Stanley Nemec MILAM, Houston, TX (US); Erik Willem TEGELAAR, Rijswijk (NL); John Justin FREEMAN, Pattison, TX (US); Richard B. TAYLOR, Sugar Land, TX (US)

(21) Appl. No.: 14/575,924

(22) Filed: Dec. 18, 2014

Related U.S. Application Data
(60) Provisional application No. 61/918,797, filed on Dec. 20, 2013.

(51) Int. Cl. C09K 8/588; E21B 43/16

(52) U.S. Cl. CPC C09K 8/588; E21B 43/16

(57) ABSTRACT

A system, composition, and process are provided for recovering oil from an oil-bearing formation. An oil recovery formulation comprising a polymer dispersed in a fluid that is at least 75 mol % dimethyl sulfide is introduced into an oil-bearing formation, and oil is produced from the formation.

### CROSS REFERENCE TO RELATED APPLICATIONS

The present application claims the benefit of pending U.S. Provisional Patent Application Ser. No. 61/918,797, filed Dec. 20, 2013, the entire reference is hereby incorporated within.

### FIELD OF THE INVENTION

The present invention is directed to a method of recovering oil from a formation, in particular, the present invention is directed to a method of enhanced oil recovery from a formation.

### BACKGROUND OF THE INVENTION

In the recovery of oil from subterranean formations, it is possible to recover only a portion of the oil in the formation using primary recovery methods utilizing the natural formation pressure to produce the oil. A portion of the oil that cannot be produced from a formation using primary recovery methods may be produced by improved or enhanced oil recovery (EOR) methods. Improved oil recovery methods include waterflooding. EOR methods include thermal EOR, miscible displacement EOR, and chemical EOR. Thermal EOR methods heat the oil in a formation to reduce the viscosity of the oil in the formation thereby mobilizing the oil for recovery. Steam flooding and fire flooding are common thermal EOR methods. Miscible displacement EOR involves the injection of a compound or mixture into a oil-bearing formation that is miscible with oil in the formation to mix with the oil and reduce the viscosity of the oil, lowering its surface tension, and swelling the oil, thereby mobilizing the oil for recovery. Typical compounds for use as miscible displacement EOR agents are gases such as CO₂ or a hydrocarbon gas such as methane. Chemical EOR involves the injection of aqueous alkaline solutions or surfactants into the formation and/or injection of polymers into the formation. The chemical EOR agent may displace oil from rock in the formation or free oil trapped in pores in the rock in the formation by reducing interfacial surface tension between oil and injected water to very low values thereby allowing trapped oil droplets to deform and flow through rock pores to form an oil bank. Water soluble polymers may be used to raise the viscosity of water to force the formed oil bank to a production well for recovery.

Relatively new EOR methods include injecting chemical solvents into an oil-bearing formation to mobilize the oil for recovery from the formation. Oil in the formation is at least partially soluble in such solvents, which typically have substantially lower viscosity than the oil. The oil and chemical solvent may mix in the formation in a manner similar to a gaseous miscible EOR agent, lowering the viscosity of the oil, reducing the surface tension of the oil, and swelling the oil, thereby mobilizing the oil for production from the formation. Chemical solvents that have been utilized for this purpose include carbon disulfide and dimethyl ether.

Improvements to existing chemical solvent EOR methods are desirable. For example, chemical solvent EOR methods that increase petroleum recovery from a formation while minimizing reservoir souring, loss of EOR agent due to its solubility in formation water, and eliminate formation clean-up required as a result of the toxicity of the EOR formulation are desired.

### SUMMARY OF THE INVENTION

In one aspect, the present invention is a process for recovering oil from an oil-bearing formation comprising: providing an oil recovery formulation that comprises a polymer dispersed in a fluid comprising at least 75 mol % dimethyl sulfide, wherein the polymer is a hydrocarbon polymer or a polymer consisting of carbon, hydrogen, and sulfur atoms, and wherein the oil recovery formulation has a dynamic viscosity of from 1 mPa·s to 5000 mPa·s at a temperature within a range of formation temperatures; introducing the oil recovery formulation into the oil-bearing formation; contacting the oil recovery formulation with oil in the formation; and producing oil from the formation after contact of the oil recovery formulation with oil in the formation.

In another aspect, the present invention is a system for producing oil from an oil-bearing formation comprising: an oil recovery formulation that comprises a polymer dispersed in a fluid comprising at least 75 mol % dimethyl sulfide, wherein the polymer is a hydrocarbon polymer or a polymer consisting of carbon, hydrogen, and sulfur atoms, and wherein the oil recovery formulation has a dynamic viscosity of from 1 mPa·s to 5000 mPa·s at a temperature within a range of formation temperatures; a first well structured and arranged to introduce the oil recovery formulation into the oil-bearing formation; and a second well located a distance from the first well, the second well being structured and arranged for producing oil from the oil-bearing formation subsequent to the introduction of the oil recovery formulation into the formation.

In a further aspect, the present invention is directed to a composition for use in oil recovery from an oil-bearing formation, comprising: a fluid comprising at least 75 mol % dimethyl sulfide; and a polymer dispersed in the fluid, wherein the polymer is selected from a hydrocarbon polymer and a polymer consisting of carbon, hydrogen, and sulfur atoms.

### BRIEF DESCRIPTION OF THE DRAWINGS

FIG. 1 is an illustration of a petroleum production system in accordance with the present invention.

FIG. 2 is a diagram of a well pattern for production of petroleum in accordance with a system and process of the present invention.

FIG. 3 is a diagram of a well pattern for production of petroleum in accordance with a system and process of the present invention.

FIG. 4 is a graph showing petroleum recovery from oil sands at 30° C. using various solvents.

FIG. 5 is a graph showing petroleum recovery from oil sands at 10° C. using various solvents.

### DETAILED DESCRIPTION OF THE INVENTION

Applicants have found that an oil recovery formulation comprising at least 75 mol % dimethyl sulfide is a highly effective chemical solvent for mobilizing oil for recovery from an oil-bearing formation. Dimethyl sulfide is first contact miscible with liquid phase oil compositions, and, in particular, is first contact miscible with oil in a oil-bearing formation so that upon introduction into the formation the oil recovery formulation may completely mix with the oil it contacts in the formation. Dimethyl sulfide is miscible with both light hydrocarbons and very heavy hydrocarbons such as asphaltenes so that dimethyl sulfide may mobilize most, or all, of liquid oil hydrocarbons in an oil-bearing formation for recovery from the formation.

While dimethyl sulfide has been found to be an excellent oil recovery agent, production of oil from an oil-bearing formation utilizing a dimethyl sulfide oil recovery formulation may be limited by an adverse mobility ratio between the oil recovery formulation and oil in the formation, particularly when the oil in the formation is relatively viscous. The mobility of a fluid in an oil-bearing formation is the ratio of the relative permeability of the fluid through the formation to the fluid viscosity of that fluid. Dimethyl sulfide has a low dynamic viscosity relative to the dynamic viscosity of typical crude oils—where dimethyl sulfide has a dynamic viscosity of 0.285 mPa·s at 25° C. and crude oils typically have a dynamic viscosity ranging from 50 mPa·s to 5000 mPa·s at 25° C. The low viscosity of the dimethyl sulfide relative to crude oil may inhibit recovery of crude oil with a dimethyl sulfide based oil recovery formulation by contributing to an adverse mobility ratio between the oil recovery formulation and the oil. An adverse mobility ratio between the dimethyl sulfide based oil recovery formulation and the oil in the formation may result in the less viscous oil recovery formulation fingering or channelling through the formation from an injecting well to a producing well. The low viscosity oil recovery formulation may establish a flow path in the formation through the channels or fingers, leaving oil in the formation through which the displacing fluid has channelled or fingered.

Applicants have found that the viscosity of a dimethyl sulfide based oil recovery formulation may be increased by incorporating a relatively small amount of a polymer that is soluble in, miscible in, or uniformly dispersible in, dimethyl sulfide. Such polymers include hydrocarbon polymers and polymers consisting of carbon, hydrogen, and sulfur atoms. The viscosity of the oil recovery formulation including a fluid comprised of at least 75 mol % dimethyl sulfide and a polymer that is soluble, miscible, or uniformly dispersible in the fluid may be increased relative to the viscosity of oil in an oil-bearing formation such that the oil recovery formulation may have a mobility ratio in the formation relative to the oil in the formation of from 0.01 to 5.

In particular, the dynamic viscosity of the dimethyl sulfide based oil recovery formulation may be increased by inclusion of the polymer therein so that the oil recovery formulation has a dynamic viscosity that is equal to or greater than the dynamic viscosity of oil in the formation at an isothermal temperature within a range of formation temperatures. The mobility ratio between the oil recovery formulation and the oil at a specific temperature may be defined by formula (I):

M=(k_{orf}μ_{orf})/(kₒ/μₒ) (I)

where M is the mobility ratio, k_{orf} is the permeability of the oil recovery formulation in the formation, μ_{orf} is the dynamic viscosity of the oil recovery formulation at the specific temperature, kₒ is the permeability of the oil in the formation, and μₒ is the dynamic viscosity of the oil at the specific temperature. Increasing the dynamic viscosity of a dimethyl sulfide based oil recovery formulation by inclusion of a polymer therein also reduces the permeability of the oil recovery formulation in the formation—both of which reduce the mobility ratio in the formula above since the permeability and the dynamic viscosity of the oil in the formation are constant. In a preferred embodiment, the oil recovery formulation of the present invention contains sufficient polymer to provide a mobility ratio of 1 or less relative to oil in the formation.

The oil recovery composition of the present invention comprises a polymer and a fluid comprising at least 75 mol % dimethyl sulfide. The fluid may comprise at least 80 mol %, or at least 85 mol %, or at least 90 mol %, or at least 95 mol %, or at least 97 mol %, or at least 99 mol % dimethyl sulfide. The fluid may consist essentially of, or may consist of, dimethyl sulfide. The fluid may comprise at least 75 wt. %, or at least 80 wt. %, or at least 85 wt. %, or at least 90 wt. %, or at least 95 wt. %, or at least 97 wt. % dimethyl sulfide. The fluid may comprise at least 75 vol. %, or at least 80 vol. %, or at least 85 vol. %, or at least 90 vol. %, or at least 95 vol. %, or at least 97 vol. % dimethyl sulfide. In a preferred embodiment, the oil recovery composition is comprised of at least 95 mol % of dimethyl sulfide.

The polymer of the oil recovery formulation composition of the present invention is a polymer that is miscible in, or soluble in, or uniformly dispersible in the fluid of the oil recovery formulation at a temperature within a range of temperatures of an oil-bearing formation or at a temperature of from 20° C. to 125° C. Polymers that are miscible in, soluble in, or uniformly dispersible in a fluid comprising at least 75 mol % dimethyl sulfide at a temperature of from 20° C. to 125° C. may include hydrocarbon polymers and polymers consisting of carbon, hydrogen, and sulfur atoms. “Hydrocarbon polymers” as used herein are defined as polymers containing only carbon and hydrogen atoms. Hydrocarbon polymers that may be utilized in the oil recovery formulation composition of the present invention include polystyrene, polyisobutylene, and liquid phase saturated hydrocarbon polymers. Hydrocarbon polymers that may be utilized in the oil recovery formulation composition of the present invention may be selected from the group consisting of polystyrene, polyisobutlyene, a polymer comprised of at least 20 wt. % of a styrene monomer and a monomer selected from the group consisting of ethylene, propylene, and butylenes, and a polymer comprised of at least 20 wt. % isobutylene and a monomer selected from the group consisting of ethylene, propylene, and butylene. A polymer consisting of carbon, hydrogen, and sulfur atoms that may be used in the oil recovery formulation of the present invention may be poly(p-phenylene sulfide), polybenzothiophene, and polythiophene. The polymer of the oil recovery formulation may be a homopolymer, a co-polymer, or a block co-polymer. The polymer of the oil recovery formulation may be free of cross-linking.

The polymer of the oil recovery formulation composition of the present invention may have from 500 to 10000 monomer units therein. The polymer of the oil recovery formulation may have a number average molecular weight or a weight average molecular weight of from 50,000 to 1,000,000.

The oil recovery formulation composition of the present invention may contain from 250 parts per million, by weight, (“ppmw”) to 250,000 ppmw of the polymer. Preferably the oil recovery formulation composition of the present invention contains as little of the polymer as necessary to provide the oil recovery formulation composition with a viscosity equal to or greater than the oil in the formation at a temperature within the range of formation temperatures or with a mobility ratio of from 0.01 to 3 relative to oil in the formation. Preferably the oil recovery formulation composition contains from 250 ppmw to 5000 ppmw, or from 250 ppmw to 1000 ppmw of the polymer.

The oil recovery formulation composition of the present invention may have a viscosity substantially greater than the viscosity of dimethyl sulfide. The oil recovery formulation composition of the present invention may have a dynamic viscosity of at least 1 mPa·s (cP), or at least 10 mPa's (cP), or at least 100 mPa's (cP), or at least 1000 mPa·s (cP), or from 1 mPa's (cP) to 5000 mPa's (cP), or from 1 mPa·s (cP) to 1000 mPa's (cP) at either 25° C., 75° C., or 125° C. Preferably the oil recovery formulation composition has a dynamic viscosity of from 1 mPa·s (cP) to 5000 mPa·s (cP) at a temperature within a range of formation temperatures of an oil-bearing formation in which the oil recovery formulation is to be used to recover oil.

The fluid of the oil recovery formulation composition of the present invention may be comprised of one or more co-solvents that form a mixture with the dimethyl sulfide. The one or more co-solvents are preferably miscible with dimethyl sulfide, and the polymer is preferably miscible in or soluble in the co-solvent. The one or more co-solvents may be selected from the group consisting of o-xylene, toluene, carbon disulfide, dichloromethane, trichloromethane, C₃-C₈ aliphatic and aromatic hydrocarbons, natural gas condensates, hydrogen sulfide, diesel, kerosene, dimethyl ether, and mixtures thereof.

The oil recovery formulation composition of the present invention provided for use in the method or system of the present invention may be first contact miscible with liquid phase oil compositions. The oil recovery formulation composition may be first contact miscible with liquid phase oil compositions including heavy crude oils, intermediate crude oils, and light crude oils, and may be first contact miscible with the oil in the oil-bearing formation. The oil recovery formulation composition may be first contact miscible with a hydrocarbon composition, for example a liquid phase crude oil, that comprises at least 25 wt. %, or at least 30 wt. %, or at least 35 wt. %, or at least 40 wt. % hydrocarbons that have a boiling point of at least 538° C. (1000° F.) as determined by ASTM Method D7169. The oil recovery formulation composition may be first contact miscible with liquid phase residue and liquid phase asphaltenes in a hydrocarbonaceous composition, for example, a crude oil. The oil recovery formulation composition may be first contact miscible with a hydrocarbon composition that comprises less than 25 wt. %, or less than 20 wt. %, or less than 15 wt. %, or less than 10 wt. %, or less than 5 wt. % of hydrocarbons having a boiling point of at least 538° C. (1000° F.) as determined by ASTM Method D7169. The oil recovery formulation composition may be first contact miscible with C₃ to C₈ aliphatic and aromatic hydrocarbons containing less than 5 wt. % oxygen and less than 5 wt. % nitrogen.

The oil recovery formulation composition may be first contact miscible with hydrocarbon compositions, for example a crude oil, over a wide range of viscosities. The oil recovery formulation composition may be first contact miscible with a hydrocarbon composition having a low or moderately low viscosity. The oil recovery formulation may be first contact miscible with a hydrocarbon composition, for example a liquid phase crude oil, having a dynamic viscosity of at most 1000 mPa·s (1000 cP), or at most 500 mPa·s (500 cP), or at most 100 mPa·s (100 cP) at 25° C. The oil recovery formulation composition may also be first contact miscible with a hydrocarbon composition having a moderately high or a high viscosity. The oil recovery formulation may be first contact miscible with a hydrocarbon composition, for example a liquid phase crude oil, having a dynamic viscosity of at least 1000 mPa·s (1000 cP), or at least 5000 mPa·s (5000 cP), or at least 10000 mPa·s (10000 cP) at 25° C. The oil recovery formulation composition may be first contact miscible with hydrocarbon composition, for example a liquid phase crude oil, having a dynamic viscosity of from 1 mPa·s (1 cP) to 5000000 mPa·s (5000000 cP), or from 100 mPa·s (100 cP) to 1000000 mPa·s (1000000 cP), or from 500 mPa·s (500 cP) to 500000 mPa·s (500000 cP), or from 1000 mPa·s (1000 cP) to 100000 mPa·s (100000 cP) at 25° C.

In the method of the present invention the oil recovery formulation composition (hereafter the “oil recovery formulation”) is introduced into an oil-bearing formation. The oil-bearing formation comprises oil that may be separated and produced from the formation after contact and mixing with the oil recovery formulation. The oil of the oil-bearing formation may be first contact miscible with the oil recovery formulation.

The oil of the oil-bearing formation may be a heavy oil containing at least 25 wt. %, or at least 30 wt. %, or at least 35 wt. %, or at least 40 wt. % of hydrocarbons having a boiling point of at least 538° C. (1000° F.) as determined in accordance with ASTM Method D7169. The heavy oil may contain at least 20 wt. % residue, or at least 25 wt. % residue, or at least 30 wt. % residue. The heavy oil may have an asphaltene content of at least at least 5 wt. %, or at least 10 wt. %, or at least 15 wt. %.

The oil contained in the oil-bearing formation may be an intermediate weight oil or a relatively light oil containing less than 25 wt. %, or less than 20 wt. %, or less than 15 wt. %, or less than 10 wt. %, or less than 5 wt. % of hydrocarbons having a boiling point of at least 538° C. (1000° F.). The intermediate weight oil or light oil may have an asphaltenes content of less than 5 wt. %.

The oil contained in the oil-bearing formation may have a dynamic viscosity under formation conditions (in particular, at temperatures within the temperature range of the formation) of at least 1 mPa·s (1 cP), or at least 10 mPa·s (10 cP), or at least 100 mPa·s (100 cP), or at least 1000 mPa·s (1000 cP), or at least 10000 mPa·s (10000 cP). The oil contained in the oil-bearing formation may have a viscosity under formation temperature conditions of from 1 to 1000000 mPa·s (1 to 1000000 cP). In an embodiment, the oil contained in the oil-bearing formation may have a viscosity under formation temperature conditions of at least 1000 mPa·s (1000 cP), where the viscosity of the oil is at least partially, or solely, responsible for immobilizing the oil in the formation.

The oil contained in the oil-bearing formation may contain little or no microcrystalline wax at formation temperature conditions. Microcrystalline wax is a solid that may be only partially soluble, or may be substantially insoluble, in the oil recovery formulation. The oil contained in the oil-bearing formation may comprise at most 3 wt. %, or at most 1 wt. %, or at most 0.5 wt. % microcrystalline wax at formation temperature conditions, and preferably the oil in the oil-bearing formation is free of microcrystalline wax at formation temperature conditions.

The oil-bearing formation may be a subterranean formation. The subterranean formation may be comprised of one or more porous matrix materials selected from the group consisting of a porous mineral matrix, a porous rock matrix, and a combination of a porous mineral matrix and a porous rock matrix, where the porous matrix material may be located beneath an overburden at a depth ranging from 50 meters to 6000 meters, or from 100 meters to 4000 meters, or from 200 meters to 2000 meters under the earth's surface. The subterranean formation may be a subsea subterranean formation.

The porous matrix material may be a consolidated matrix material in which at least a majority, and preferably substantially all, of the rock and/or mineral that forms the matrix material is consolidated such that the rock and/or mineral forms a mass in which substantially all of the rock and/or mineral is immobile when oil, the oil recovery formulation, water, or other fluid is passed therethrough. Preferably at least 95 wt. % or at least 97 wt. %, or at least 99 wt. % of the rock and/or mineral is immobile when oil, the oil recovery formulation, water, or other fluid is passed therethrough so that any amount of rock or mineral material dislodged by the passage of the oil, oil recovery formulation, water, or other fluid is insufficient to render the formation impermeable to the flow of the oil recovery formulation, oil, water, or other fluid through the formation. The porous matrix material may be an unconsolidated matrix material in which at least a majority, or substantially all, of the rock and/or mineral that forms the matrix material is unconsolidated. The formation may have a permeability of from 0.000001 to 15 Darcys, or from 0.001 to 1 Darcy. The rock and/or mineral porous matrix material of the formation may be comprised of sandstone and/or a carbonate selected from dolomite, limestone, and mixtures thereof—where the limestone may be microcrystalline or crystalline limestone and/or chalk. The porous matrix material may be comprised of shale.

Oil in the oil-bearing formation may be located in pores within the porous matrix material of the formation. The oil in the oil-bearing formation may be immobilized in the pores within the porous matrix material of the formation, for example, by capillary forces, by interaction of the oil with the pore surfaces, by the viscosity of the oil, or by interfacial tension between the oil and water in the formation.

The oil-bearing formation may also be comprised of water, which may be located in pores within the porous matrix material. The water in the formation may be connate water, water from a secondary or tertiary oil recovery process water-flood, or a mixture thereof. The water in the oil-bearing formation may be positioned to immobilize oil within the pores. Contact of the oil recovery formulation with the oil in the formation may mobilize the oil in the formation for production and recovery from the formation by freeing at least a portion of the oil from pores within the formation.

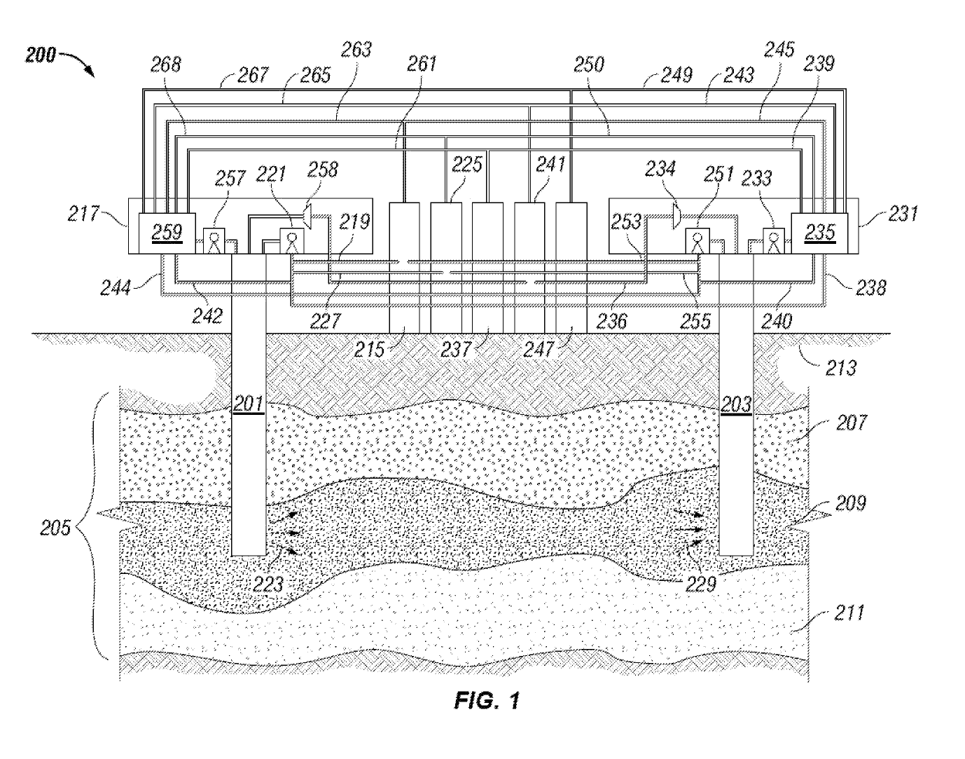

Referring now to FIG. 1, a system 200 of the present invention for practicing a method of the present invention is shown. The system includes a first well 201 and a second well 203 extending into an oil-bearing formation 205 such as described above. The oil-bearing formation 205 may be comprised of one or more formation portions 207, 209, and 211 formed of porous material matrices, such as described above, located beneath an overburden 213. The system of the present invention includes an oil recovery formulation as described above, and in the method of the present invention an oil recovery formulation as described above is provided. The oil recovery formulation may be provided from an oil recovery formulation storage facility 215 fluidly operatively coupled to a first injection/production facility 217 via conduit 219. First injection/production facility 217 may be fluidly operatively coupled to the first well 201, which may be located extending from the first injection/production facility 217 into the oil-bearing formation 205. The oil recovery formulation may flow from the first injection/production facility 217 through the first well to be introduced into the formation 205, for example in formation portion 209, where the first injection/production facility 217 and the first well, or the first well itself, include(s) a mechanism for introducing the oil recovery formulation into the formation. Alternatively, the oil recovery formulation may flow from the oil recovery formulation storage facility 215 directly to the first well 201 for injection into the formation 205, where the first well comprises a mechanism for introducing the oil recovery formulation into the formation. The mechanism for introducing the oil recovery formulation into the formation 205 via the first well 201—located in the first injection/production facility 217, the first well 201, or both—may be comprised of a pump 221 for delivering the oil recovery formulation to perforations or openings in the first well through which the oil recovery formulation may be introduced into the formation.

The oil recovery formulation may be introduced into the formation 205, for example by injecting the oil recovery formulation into the formation through the first well 201 by pumping the oil recovery formulation through the first well and into the formation. The pressure at which the oil recovery formulation may be injected into the formation may range from 10% to 95%, or from 20% to 90%, or from 25% to 75% of the fracture pressure of the formation. Alternatively, the oil recovery formulation may be injected into the formation at a pressure above the fracture pressure of the formation. The pressure at which the oil recovery formulation is injected into the formation may range from a pressure from greater than 0 MPa to 37 MPa above the initial formation pressure as measured prior to when the injection begins.

The volume of oil recovery formulation introduced into the formation 205 via the first well 201 may range from 0.001 to 5 pore volumes, or from 0.01 to 2 pore volumes, or from 0.1 to 1 pore volumes, or from 0.2 to 0.6 pore volumes, where the term “pore volume” refers to the volume of the formation that may be swept by the oil recovery formulation between the first well 201 and the second well 203. The pore volume may be readily be determined by methods known to a person skilled in the art, for example by modelling studies or by injecting water having a tracer contained therein through the formation 205 from the first well 201 to the second well 203.

As the oil recovery formulation is introduced into the formation 205, the oil recovery formulation spreads into the formation as shown by arrows 223. Upon introduction to the formation 205, the oil recovery formulation contacts and forms a mixture with a portion of the oil in the formation. The oil recovery formulation may be first contact miscible with the oil in the formation 205, where the oil recovery formulation may mobilize the oil in the formation upon contacting and mixing with the oil. The oil recovery formulation may mobilize the oil in the formation upon contacting and mixing with the oil, for example, by reducing the viscosity of the mixture relative to the native oil in the formation, by reducing the capillary forces retaining the oil in pores in the formation, by reducing the wettability of the oil on pore surfaces in the formation, by reducing the interfacial tension between petroleum and water in the pores in the formation, and/or by swelling the oil in the pores in the formation.

The viscosity of the oil recovery formulation and the mobility ratio of the oil recovery formulation relative to oil in the formation may inhibit fingering or channelling of the oil recovery formulation through oil in the formation or fingering or channelling of the oil through the oil recovery formulation as the oil recovery formulation moves through the formation. The oil recovery formulation, therefore, may mix with, mobilize, and drive the oil in the formation in a piston-like flow through the formation. Oil recovery from the formation may be enhanced by the piston-like flow of the oil recovery formulation through the formation since less oil may be stranded in the formation due to channelling or fingering of the oil recovery formulation through the formation.

The mobilized mixture of the oil recovery formulation and oil and any unmixed oil recovery formulation may be pushed across the formation 205 from the first well 201 to the second well 203 by further introduction of more oil recovery formulation or by providing an oil immiscible formulation and introducing the oil immiscible formulation into the formation subsequent to introduction of the oil recovery formulation into the formation. The oil immiscible formulation may be introduced into the formation 205 through the first well 201 after completion of introduction of the oil recovery formulation into the formation to force or otherwise displace the mobilized mixture of the oil recovery formulation and oil as well as any unmixed oil recovery formulation toward the second well 203 for production. Any unmixed oil recovery formulation may mix with and mobilize more oil in the formation 205 as the unmixed oil recovery formulation is displaced through the formation from the first well 201 towards the second well 203.

The oil immiscible formulation may be configured to displace the mobilized mixture of oil recovery formulation and oil as well as any unmixed oil recovery formulation through the formation 205. Suitable oil immiscible formulations are not first contact miscible or multiple contact miscible with oil in the formation 205. The oil immiscible formulation may be selected from the group consisting of an aqueous polymer fluid, water in gas or liquid form, carbon dioxide at a pressure below its minimum miscibility pressure, nitrogen at a pressure below its minimum miscibility pressure, air, and mixtures of two or more of the preceding.

Suitable polymers for use in an aqueous polymer fluid may include, but are not limited to, polyacrylamides, partially hydrolyzed polyacrylamides, polyacrylates, ethylenic copolymers, biopolymers, carboxymethylcellulose, polyvinyl alcohols, polystyrene sulfonates, polyvinylpyrolidones, AMPS (2-acrylamide-2-methyl propane sulfonate), combinations thereof, or the like. Examples of ethylenic copolymers include copolymers of acrylic acid and acrylamide, acrylic acid and lauryl acrylate, lauryl acrylate and acrylamide. Examples of biopolymers include xanthan gum, guar gum, alginic acids, and alginate salts. In some embodiments, the polymers of the oil immiscible formulation may be crosslinked in situ in the formation 205. In other embodiments, the polymers of the oil immiscible formulation may be generated in situ in the formation 205.

The oil immiscible formulation may be stored in, and provided for introduction into the formation 205 from, an oil immiscible formulation storage facility 225 that may be fluidly operatively coupled to the first injection/production facility 217 via conduit 227. The first injection/production facility 217 may be fluidly operatively coupled to the first well 201 to provide the oil immiscible formulation to the first well for introduction into the formation 205. Alternatively, the oil immiscible formulation storage facility 225 may be fluidly operatively coupled to the first well 201 directly to provide the oil immiscible formulation to the first well for introduction into the formation 205. The first injection/production facility 217 and the first well 201, or the first well itself, may comprise a mechanism for introducing the oil immiscible formulation into the formation 205 via the first well 201. The mechanism for introducing the oil immiscible formulation into the formation 205 via the first well 201 may be comprised of a pump or a compressor for delivering the oil immiscible formulation to perforations or openings in the first well through which the oil immiscible formulation may be injected into the formation. The mechanism for introducing the oil immiscible formulation into the formation 205 via the first well 201 may be the pump 221 utilized to inject the oil recovery formulation into the formation via the first well 201.

The oil immiscible formulation may be introduced into the formation 205, for example, by injecting the oil immiscible formulation into the formation through the first well 201 by pumping the oil immiscible formulation through the first well and into the formation. The pressure at which the oil immiscible formulation may be injected into the formation 205 through the first well 201 may be up to, but not including, the fracture pressure of the formation, or from 10% to 99%, or from 20% to 95%, or from 25% to 90% of the fracture pressure of the formation. In an embodiment of the present invention, the oil immiscible formulation may be injected into the formation 205 at a pressure from greater than 0 MPa to 37 MPa above the formation pressure as measured prior to injection of the oil immiscible formulation.

The amount of oil immiscible formulation introduced into the formation 205 via the first well 201 following introduction of the oil recovery formulation into the formation via the first well may range from 0.001 to 5 pore volumes, or from 0.01 to 2 pore volumes, or from 0.1 to 1 pore volumes, or from 0.2 to 0.6 pore volumes, where the term “pore volume” refers to the volume of the formation that may be swept by the oil immiscible formulation between the first well and the second well. The amount of oil immiscible formulation introduced into the formation 205 should be sufficient to drive the mobilized oil/oil recovery formulation mixture and any unmixed oil recovery formulation across at least a portion of the formation. If the oil immiscible formulation is in liquid phase, the volume of oil immiscible formulation introduced into the formation 205 following introduction of the oil recovery formulation into the formation relative to the volume of oil recovery formulation introduced into the formation immediately preceding introduction of the oil immiscible formulation may range from 0.1:1 to 100:1 of oil immiscible formulation to oil recovery formulation, more preferably from 1:1 to 10:1 of oil immiscible formulation to oil recovery formulation. If the oil immiscible formulation is in gaseous phase, the volume of oil immiscible formulation introduced into the formation 205 following introduction of the oil recovery formulation into the formation relative to the volume of oil recovery formulation introduced into the formation immediately preceding introduction of the oil immiscible formulation may be substantially greater than a liquid phase oil immiscible formulation, for example, at least 10 or at least 20, or at least 50 volumes of gaseous phase oil immiscible formulation per volume of oil recovery formulation introduced immediately preceding introduction of the gaseous phase oil immiscible formulation.

If the oil immiscible formulation is in liquid phase, the oil immiscible formulation may have a viscosity of at least the same magnitude as the viscosity of the mobilized oil/oil recovery formulation mixture at formation temperature conditions to enable the oil immiscible formulation to drive the mixture of mobilized oil/oil recovery formulation across the formation 205 to the second well 203. The oil immiscible formulation may have a viscosity of at least 1 mPa's (1 cP) or at least 10 mPa's (10 cP), or at least 50 mPa·s (50 cP), or at least 100 mPa's (100 cP), or at least 500 mPa·s (500 cP), or at least 1000 mPa·s (1000 cP) at formation temperature conditions or at 25° C. If the oil immiscible formulation is in liquid phase, preferably the oil immiscible formulation has a viscosity at least one order of magnitude greater than the viscosity of the mobilized oil/oil recovery formulation mixture at formation temperature conditions so the oil immiscible formulation may drive the mobilized oil/oil recovery formulation mixture across the formation in plug flow. The plug of oil immiscible formulation may minimize and inhibit fingering of the mobilized oil/oil recovery formulation mixture through the oil immiscible formulation as the oil immiscible formulation drives the mobilized oil/oil recovery formulation mixture through the formation.

The oil recovery formulation and the oil immiscible formulation may be introduced into the formation through the first well 201 in alternating slugs. For example, the oil recovery formulation may be introduced into the formation 205 through the first well 201 for a first time period, after which the oil immiscible formulation may be introduced into the formation through the first well for a second time period subsequent to the first time period, after which the oil recovery formulation may be introduced into the formation through the first well for a third time period subsequent to the second time period, after which the oil immiscible formulation may be introduced into the formation through the first well for a fourth time period subsequent to the third time period. As many alternating slugs of the oil recovery formulation and the oil immiscible formulation may be introduced into the formation through the first well as desired.

Oil may be mobilized for production from the formation 205 via the second well 203 by introduction of the oil recovery formulation, and optionally the oil immiscible formulation, into the formation, where the mobilized oil is driven through the formation for production from the second well as indicated by arrows 229 by introduction of the oil recovery formulation, and optionally the oil immiscible formulation, into the formation via the first well 201. The oil mobilized for production from the formation 205 may include the mobilized oil/oil recovery formulation mixture. Water and/or gas may also be mobilized for production from the formation 205 via the second well 203 by introduction of the oil recovery formulation into the formation via the first well 201.

After introduction of the oil recovery formulation into the formation 205 via the first well 201, oil may be recovered and produced from the formation via the second well 203. The system may include a mechanism located at the second well for recovering and producing the oil from the formation 205 subsequent to introduction of the oil recovery formulation into the formation. The mechanism located at the second well 203 for recovering and producing the oil may be comprised of a pump 233, which may be located in the second injection/production facility 231 and/or within the second well 203. The pump 233 may draw the oil from the formation 205 through perforations in the second well 203 to deliver the oil to the second injection/production facility 231.

Alternatively, the mechanism for recovering and producing the oil from the formation 205 may be comprised of a compressor 234 that may be located in the second injection/production facility 231. The compressor 234 may be fluidly operatively coupled to a gas storage tank 241 via conduit 236, and may compress gas from the gas storage tank for injection into the formation 205 through the second well 203. The compressor may compress the gas to a pressure sufficient to drive production of oil from the formation via the second well 203, where the appropriate pressure may be determined by conventional methods known to those skilled in the art. The compressed gas may be injected into the formation from a different position on the second well 203 than the well position at which the oil is produced from the formation, for example, the compressed gas may be injected into the formation at formation portion 207 while oil is produced from the formation at formation portion 209.

Oil, optionally in a mixture with the oil recovery formulation, oil immiscible formulation, water, and/or gas may be drawn from the formation 205 as shown by arrows 229 and produced up the second well 203 to the second injection/production facility 231. The oil may be separated from gas and/or water in a separation unit 235 located in the second injection/production facility 231 and fluidly coupled to the mechanism 233 for recovering and producing oil from the formation. The separation unit 235 may be comprised of a conventional liquid-gas separator for separating gas from the oil and water; and a conventional hydrocarbon-water separator for separating the oil from water and optionally from the liquid oil immiscible formulation.

The separated produced oil may be provided from the separation unit 235 of the second injection/production facility 231 to a liquid storage tank 237, which may be fluidly operatively coupled to the separation unit 235 of the second injection/production facility by conduit 239. The separated gas, if any, may be provided from the separation unit 235 of the second injection/production facility 231 to the gas storage tank 241, which may be fluidly operatively coupled to the separation unit 235 of the second injection/production facility 231 by conduit 243. Separated water may be provided from the separation unit 235 of the second injection/production facility 231 to a water tank 247, which may be fluidly operatively coupled to the separation unit 235 of the second injection/production facility 231 by conduit 249.

In an embodiment of a system and a method of the present invention, the first well 201 may be used for injecting the oil recovery formulation into the formation 205 and the second well 203 may be used to produce oil from the formation as described above for a first time period, and the second well 203 may be used for injecting the oil recovery formulation into the formation 205 to mobilize the oil in the formation and drive the mobilized oil across the formation to the first well and the first well 201 may be used to produce oil from the formation for a second time period, where the second time period is subsequent to the first time period. The second injection/production facility 231 may comprise a mechanism such as pump 251 that is fluidly operatively coupled the oil recovery formulation storage facility 215 by conduit 253 and that is fluidly operatively coupled to the second well 203 to introduce the oil recovery formulation into the formation 205 via the second well. The pump 251 or a compressor may also be fluidly operatively coupled to the oil immiscible formulation storage facility 225 by conduit 255 to introduce the oil immiscible formulation into the formation 205 via the second well 203 subsequent to introduction of the oil recovery formulation into the formation via the second well. The first injection/production facility 217 may comprise a mechanism such as pump 257 or compressor 258 for production of oil from the formation 205 via the first well 201. The first injection/production facility 217 may also include a separation unit 259 for separating oil, water, and/or gas. The separation unit 259 may be comprised of a conventional liquid-gas separator for separating gas from the oil and water; and a conventional hydrocarbon-water separator for separating the oil from water and optionally from liquid oil immiscible formulation. The separation unit 259 may be fluidly operatively coupled to: the liquid storage tank 237 by conduit 261 for storage of produced oil in the liquid storage tank; the gas storage tank 241 by conduit 265 for storage of produced gas in the gas storage tank; and the water tank 247 by conduit 267 for storage of produced water in the water tank.

The first well 201 may be used for introducing the oil recovery formulation—and, optionally, subsequent to introduction of the oil recovery formulation via the first well, the oil immiscible formulation—into the formation 205 and the second well 203 may be used for producing oil from the formation for a first time period; then the second well 203 may be used for injecting the oil recovery formulation—and, optionally, subsequent to introduction of the oil recovery formulation via the second well, the oil immiscible formulation—into the formation 205 and the first well 201 may be used for producing oil from the formation for a second time period, where the first and second time periods comprise a cycle. Multiple cycles may be conducted which include alternating the first well 201 and the second well 203 between introducing the oil recovery formulation into the formation 205—and, optionally introducing the oil immiscible formulation into the formation subsequent to introduction of the oil recovery formulation—and producing oil from the formation, where one well is injecting and the other is producing for the first time period, and then they are switched for a second time period. A cycle may be from about 12 hours to about 1 year, or from about 3 days to about 6 months, or from about 5 days to about 3 months. In some embodiments, the oil recovery formulation may be introduced into the formation at the beginning of the first time period of and/or the second time period of a cycle, and an oil immiscible formulation may be introduced at the end of the first time period and/or the second time period of a cycle. In some embodiments, the beginning of the first time period or the second time period of a cycle may be the first 10% to about 80% of the first time period or the second time period of a cycle, or the first 20% to about 60% of the first time period or the second time period of a cycle, the first 25% to about 40% of the first time period or the second time period of a cycle, and the end may be the remainder of the first time period or the second time period of a cycle.

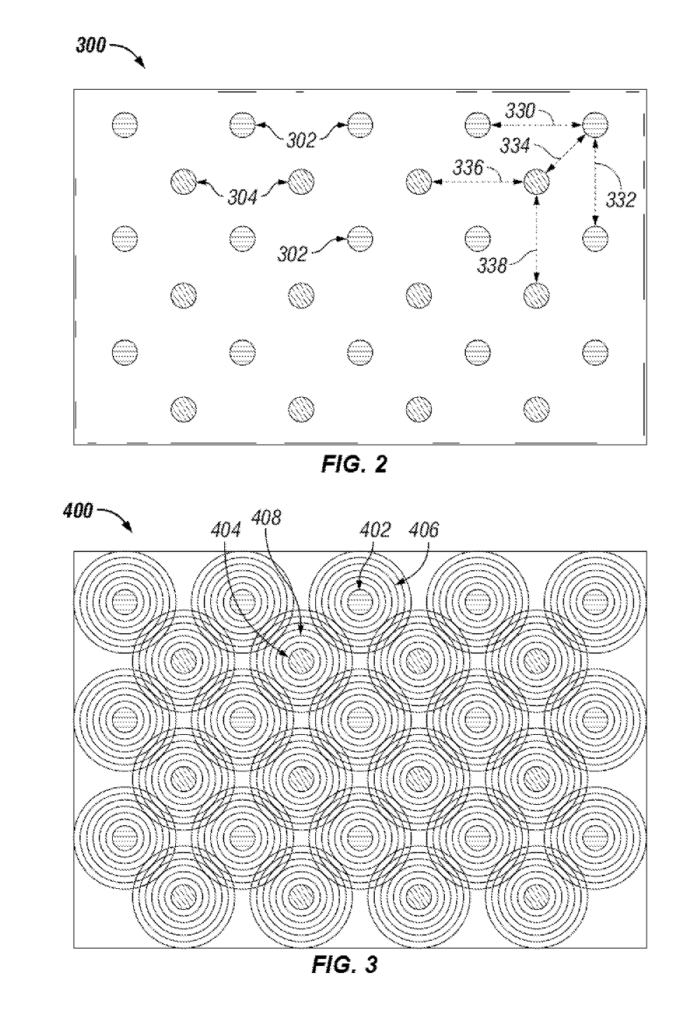

Referring now to FIG. 2, an array of wells 300 is illustrated. Array 300 includes a first well group 302 (denoted by horizontal lines) and a second well group 304 (denoted by diagonal lines). In some embodiments of the system and method of the present invention, the first well of the system and method described above may include multiple first wells depicted as the first well group 302 in the array 300, and the second well of the system and method described above may include multiple second wells depicted as the second well group 304 in the array 300.

Each well in the first well group 302 may be a horizontal distance 330 from an adjacent well in the first well group 302. The horizontal distance 330 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters. Each well in the first well group 302 may be a vertical distance 332 from an adjacent well in the first well group 302. The vertical distance 332 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the second well group 304 may be a horizontal distance 336 from an adjacent well in the second well group 304. The horizontal distance 336 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters. Each well in the second well group 304 may be a vertical distance 338 from an adjacent well in the second well group 304. The vertical distance 338 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the first well group 302 may be a distance 334 from the adjacent wells in the second well group 304. Each well in the second well group 304 may be a distance 334 from the adjacent wells in first well group 302. The distance 334 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the first well group 302 may be surrounded by four wells in the second well group 304. Each well in the second well group 304 may be surrounded by four wells in the first well group 302.

In some embodiments, the array of wells 300 may have from about 10 to about 1000 wells, for example from about 5 to about 500 wells in the first well group 302, and from about 5 to about 500 wells in the second well group 304.

In some embodiments, the array of wells 300 may be seen as a top view with first well group 302 and the second well group 304 being vertical wells spaced on a piece of land. In some embodiments, the array of wells 300 may be seen as a cross-sectional side view of the formation with the first well group 302 and the second well group 304 being horizontal wells spaced within the formation.

Referring now to FIG. 3, an array of wells 400 is illustrated. Array 400 includes a first well group 402 (denoted by horizontal lines) and a second well group 404 (denoted by diagonal lines). The array 400 may be an array of wells as described above with respect to array 300 in FIG. 2. In some embodiments of the system and method of the present invention, the first well of the system and method described above may include multiple first wells depicted as the first well group 402 in the array 400, and the second well of the system and method described above may include multiple second wells depicted as the second well group 404 in the array 400.

The oil recovery formulation may be injected into first well group 402 and oil may be recovered and produced from the second well group 404. As illustrated, the oil recovery formulation may have an injection profile 406, and oil may be produced from the second well group 404 having an oil recovery profile 408.

The oil recovery formulation may be injected into the second well group 404 and oil may be produced from the first well group 402. As illustrated, the oil recovery formulation may have an injection profile 408, and oil may be produced from the first well group 402 having an oil recovery profile 406.

The first well group 402 may be used for injecting the oil recovery formulation and the second well group 404 may be used for producing oil from the formation for a first time period; then second well group 404 may be used for injecting the oil recovery formulation and the first well group 402 may be used for producing oil from the formation for a second time period, where the first and second time periods comprise a cycle. In some embodiments, multiple cycles may be conducted which include alternating first and second well groups 402 and 404 between injecting the oil recovery formulation and producing oil from the formation, where one well group is injecting and the other is producing for a first time period, and then they are switched for a second time period.

To facilitate a better understanding of the present invention, the following examples of certain aspects of some embodiments are given. In no way should the following examples be read to limit, or define, the scope of the invention.

### EXAMPLES

### Example 1

The quality of dimethyl sulfide as an oil recovery agent based on the miscibility of dimethyl sulfide with a crude oil relative to other compounds was evaluated. The miscibility of dimethyl sulfide, ethyl acetate, o-xylene, carbon disulfide, chloroform, dichloromethane, tetrahydrofuran, and pentane solvents with mined oil sands was measured by extracting the oil sands with the solvents at 10° C. and at 30° C. to determine the fraction of hydrocarbons extracted from the oil sands by the solvents. The bitumen content of the mined oil sands was measured at 11 wt. % as an average of bitumen extraction yield values for solvents known to effectively extract substantially all of bitumen from oil sands—in particular chloroform, dichloromethane, o-xylene, tetrahydrofuran, and carbon disulfide. One oil sands sample per solvent per extraction temperature was prepared for extraction, where the solvents used for extraction of the oil sands samples were dimethyl sulfide, ethyl acetate, o-xylene, carbon disulfide, chloroform, dichloromethane, tetrahydrofuran, and pentane. Each oil sands sample was weighed and placed in a cellulose extraction thimble that was placed on a porous polyethylene support disk in a jacketed glass cylinder with a drip rate control valve. Each oil sands sample was then extracted with a selected solvent at a selected temperature (10° C. or 30° C.) in a cyclic contact and drain experiment, where the contact time ranged from 15 to 60 minutes. Fresh contacting solvent was applied and the cyclic extraction repeated until the fluid drained from the apparatus became pale brown in color.

The extracted fluids were stripped of solvent using a rotary evaporator and thereafter vacuum dried to remove residual solvent. The recovered bitumen samples all had residual solvent present in the range of from 3 wt. % to 7 wt. %. The residual solids and extraction thimble were air dried, weighed, and then vacuum dried. Essentially no weight loss was observed upon vacuum drying the residual solids, indicating that the solids did not retain either extraction solvent or easily mobilized water. Collectively, the weight of the solid or sample and thimble recovered after extraction plus the quantity of bitumen recovered after extraction divided by the weight of the initial oil sands sample plus the thimble provide the mass closure for the extractions. The calculated percent mass closure of the samples was slightly high because the recovered bitumen values were not corrected for the 3 wt. % to 7 wt. % residual solvent. The extraction experiment results are summarized in Table 1.

TABLE 1
Summary of Extraction Experiments of Bituminous Oil Sands with Various Fluids

| | | Input | Output | | | Experimental |
|---|---|---|---|---|---|---|
| | Temperature, | Solids | Solids | Weight | Recovered | Weight |
| Extraction Fluid | C. | weight, g | weight, g | Change, g | Bitumen, g | Closure, % |
| Carbon Disulfide | 30 | 151.1 | 134.74 | 16.4 | 16.43 | 100.0 |
| Carbon Disulfide | 10 | 151.4 | 134.62 | 16.8 | 16.62 | 99.9 |
| Chloroform | 30 | 153.7 | 134.3 | 19.4 | 18.62 | 99.5 |
| Chloroform | 10 | 156.2 | 137.5 | 18.7 | 17.85 | 99.5 |
| Dichloromethane | 30 | 155.8 | 138.18 | 17.7 | 16.30 | 99.1 |
| Dichloromethane | 10 | 155.2 | 136.33 | 18.9 | 17.66 | 99.2 |
| o-Xylene | 30 | 156.1 | 136.58 | 19.5 | 17.37 | 98.6 |
| o-Xylene | 10 | 154.0 | 136.66 | 17.3 | 17.36 | 100.0 |
| Tetrahydrofuran | 30 | 154.7 | 136.73 | 18.0 | 17.67 | 99.8 |
| Tetrahydrofuran | 10 | 154.7 | 136.98 | 17.7 | 16.72 | 99.4 |
| Ethyl Acetate | 30 | 153.5 | 135.81 | 17.7 | 11.46 | 96.0 |
| Ethyl Acetate | 10 | 155.7 | 144.51 | 11.2 | 10.32 | 99.4 |
| Pentane | 30 | 154.0 | 139.11 | 14.9 | 13.49 | 99.1 |
| Pentane | 10 | 152.7 | 138.65 | 14.1 | 13.03 | 99.3 |
| Dimethyl Sulfide | 30 | 154.2 | 137.52 | 16.7 | 16.29 | 99.7 |
| Dimethyl Sulfide | 10 | 151.7 | 134.77 | 16.9 | 16.55 | 99.7 |

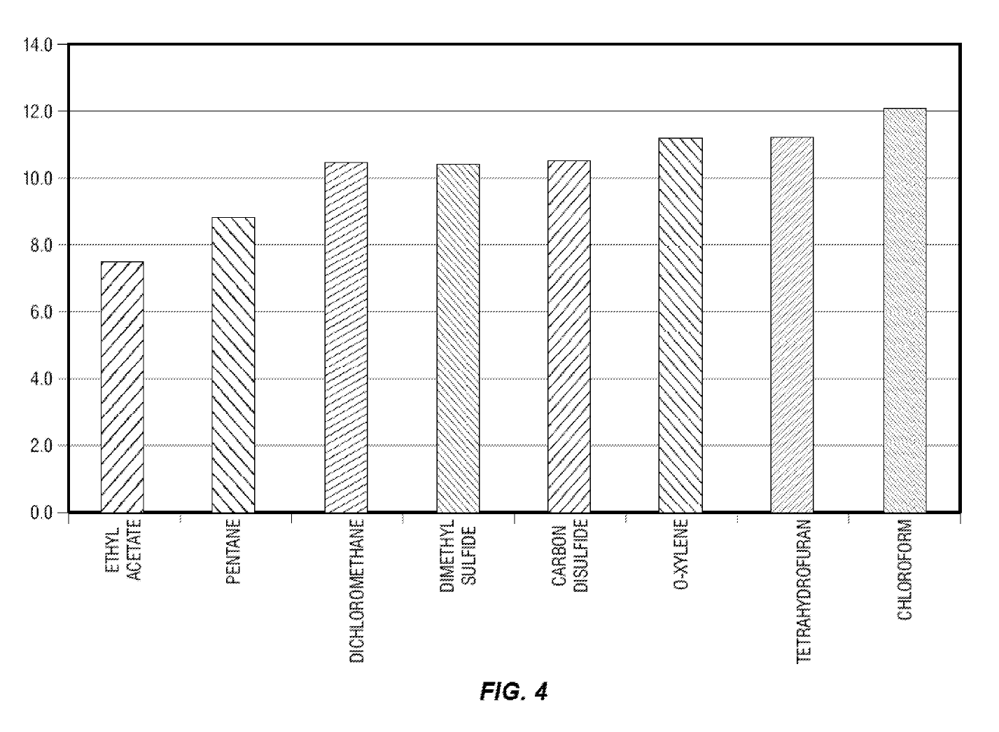

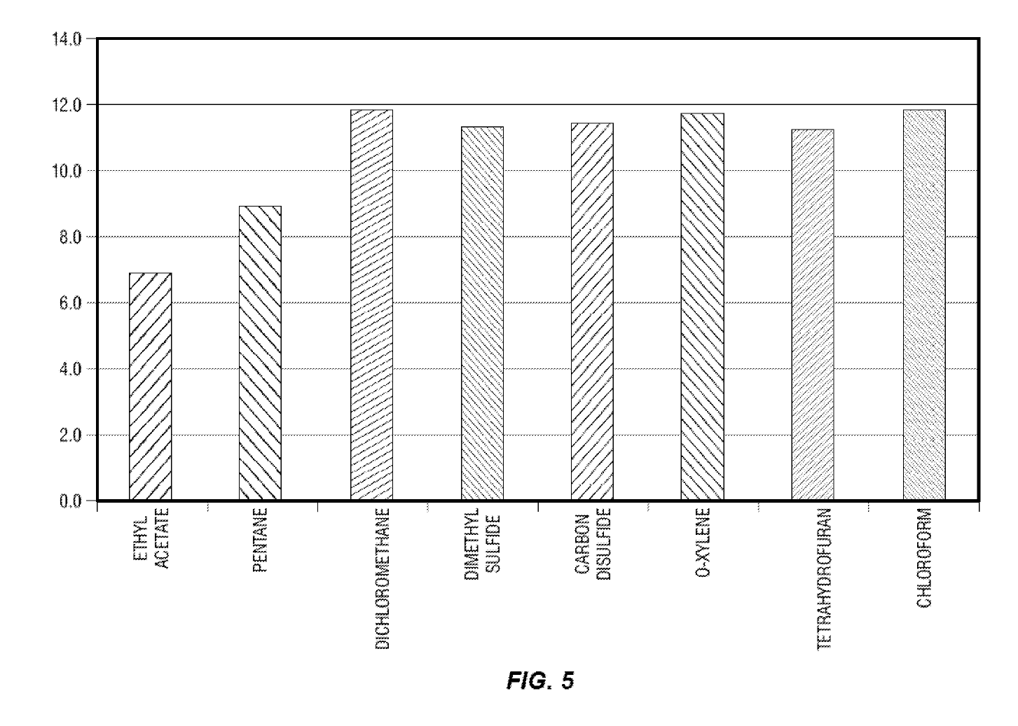

FIG. 4 provides a graph plotting the weight percent yield of extracted bitumen as a function of the extraction fluid at 30° C. applied with a correction factor for residual extraction fluid in the recovered bitumen, and FIG. 5 provides a similar graph for extraction at 10° C. without a correction factor. FIGS. 4 and 5 and Table 1 show that dimethyl sulfide is comparable for recovering bitumen from an oil sand material with the best known fluids for recovering bitumen from an oil sand material—o-xylene, chloroform, carbon disulfide, dichloromethane, and tetrahydrofuran—and is significantly better than pentane and ethyl acetate.

The bitumen samples extracted at 30° C. from each oil sands sample were evaluated by SARA analysis to determine the saturates, aromatics, resins, and asphaltenes composition of the bitumen samples extracted by each solvent. The results are shown in Table 2.

TABLE 2
SARA Analysis of Extracted Bitumen Samples
as a Function of Extraction Fluid

| | Oil Composition Normalized Weight Percent | | | |
|---|---|---|---|---|
| Extraction Fluid | Saturates | Aromatics | Resins | Asphaltenes |
| Ethyl Acetate | 21.30 | 53.72 | 22.92 | 2.05 |
| Pentane | 22.74 | 54.16 | 22.74 | 0.36 |
| Dichloromethane | 15.79 | 44.77 | 24.98 | 14.45 |
| Dimethyl Sulfide | 15.49 | 47.07 | 24.25 | 13.19 |
| Carbon Disulfide | 18.77 | 41.89 | 25.49 | 13.85 |
| o-Xylene | 17.37 | 46.39 | 22.28 | 13.96 |
| Tetrahydrofuran | 16.11 | 45.24 | 24.38 | 14.27 |
| Chloroform | 15.64 | 43.56 | 25.94 | 14.86 |

The SARA analysis showed that pentane and ethyl acetate were much less effective for extraction of asphaltenes from oil sands than are the known highly effective bitumen extraction fluids dichloromethane, carbon disulfide, o-xylene, tetrahydrofuran, and chloroform. The SARA analysis also showed that dimethyl sulfide has excellent miscibility properties for even the most difficult hydrocarbons—asphaltenes.

The data showed that dimethyl sulfide is generally as good as the recognized very good bitumen extraction fluids for recovery of bitumen from oil sands, and is highly compatible with saturates, aromatics, resins, and asphaltenes.

### Example 2

Incremental recovery of oil from a formation core using an oil recovery formulation consisting of dimethyl sulfide following oil recovery from the core by water-flooding was measured to evaluate the effectiveness of DMS as a tertiary oil recovery agent.

Two 5.02 cm long Berea sandstone cores with a core diameter of 3.78 cm and a permeability between 925 and 1325 mD were saturated with a brine having a composition as set forth in Table 3.

TABLE 3
Brine Composition

| | Chemical component | | | | | |
|---|---|---|---|---|---|---|
| | CaCl₂ | MgCl₂ | KCl | NaCl | Na₂SO₄ | NaHCO₃ |
| Concentration | 0.386 | 0.523 | 1.478 | 28.311 | 0.072 | 0.181 |
| (kppm) | | | | | | |

After saturation of the cores with brine, the brine was displaced by a Middle Eastern Asphaltic crude oil having the characteristics as set forth in Table 4 to saturate the cores with oil.

TABLE 4
Middle Eastern Asphaltic Crude Oil Properties

| | | | |
|---|---|---|---|
| Hydrogen (wt. %) | 13.21 | 11.62 | 10.1 |
| Carbon (wt. %) | 86.46 | 86.55 | 82 |
| Oxygen (wt. %) | na | na | 0.62 |
| Nitrogen (wt. %) | 0.166 | 0.184 | 0.37 |
| Sulfur (wt. %) | 0.124 | 1.61 | 6.69 |
| Nickel (ppm wt.) | 32 | 14.2 | 70 |
| Vanadium (ppm wt.) | 1 | 11.2 | 205 |
| microcarbon residue (wt. %) | na | 8.50 | 12.5 |
| C₅ Asphaltenes (wt. %) | <0.1 | na | 16.2 |
| C₇ Asphaltenes (wt. %) | <0.1 | na | 10.9 |
| Density (g/ml) (15.6° C.) | 0.88 | 0.9509 | 1.01 |
| API Gravity (15.6° C.) | 28.1 | 17.3 | 8.5 |
| Water (Karl Fisher Titration) (wt. %) | 1.65 | <0.1 | <0.1 |
| TAN-E (ASTM D664) (mg KOH/g) | 1.34 | 4.5 | 3.91 |
| Volatiles Removed by Topping, wt % | 21.6 | 0 | 0 |
| Saturates in Topped Fluid, wt. % | 60.4 | 41.7 | 12.7 |
| Aromatics in Topped Fluid, wt. % | 31.0 | 40.5 | 57.1 |
| Resin in Topped Fluid, wt. % | 8.5 | 14.5 | 17.1 |
| Asphaltenes in Topped Fluid, wt. % | 0.1 | 3.4 | 13.1 |

Boiling Range Distribution

| | | | |
|---|---|---|---|
| Initial Boiling Point - 204° C. (wt. %) | 8.5 | 3.0 | 0 |
| 204° C.-260° C. (wt. %) | 9.5 | 5.8 | 1.0 |
| 260° C.-343° C. (wt. %) | 16.0 | 14.0 | 14.0 |
| 343° C.-538° C. (wt. %) | 39.5 | 42.9 | 38.0 |
| >538° C. (wt. %) | 26.5 | 34.3 | 47.0 |

Oil was recovered from each oil saturated core by the addition of brine to the core under pressure and by subsequent addition of DMS to the core under pressure. Each core was treated as follows to determine the amount of oil recovered from the core by addition of brine followed by addition of DMS. Oil was initially displaced from the core by addition of brine to the core under pressure. A confining pressure of 1 MPa was applied to the core during addition of the brine, and the flow rate of brine to the core was set at 0.05 ml/min. The core was maintained at a temperature of 50° C. during displacement of oil from the core with brine. Oil was produced and collected from the core during the displacement of oil from the core with brine until no further oil production was seen (24 hours). After no further oil was displaced from the core by the brine, oil was displaced from the core by addition of DMS to the core under pressure. DMS was added to the core at a flow rate of 0.05 ml/min for a period of 32 for the first core and for a period of 15 hours for the second core. Oil displaced from the core during the addition of DMS to the core was collected separately from the oil displaced by the addition of brine to the core.

The oil samples collected from the core by brine displacement and by DMS displacement were isolated from water by extraction with dichloromethane, and drying the separated organic layer over sodium sulfate. After evaporation of volatiles from the separated, dried organic layer of each oil sample, the amount of oil displaced by brine addition to a core and the amount of oil displaced by DMS addition to the core were weighed. Volatiles were also evaporated from a sample of the Middle Eastern asphaltic oil to be able to correct for loss of light-end compounds during evaporation. Table 5 shows the amount of oil produced from each core by brine displacement followed by DMS displacement.

TABLE 5

| | | Oil produced | | Oil produced |
|---|---|---|---|---|
| | Oil produced | Brine dis- | Oil produced | DMS dis- |
| | Brine | placement | DMS | placement |
| | displacement | (of % oil ini- | displacement | (of % oil ini- |
| | (ml) | tially in core) | (ml) | tially in core) |
| Core 1 | 4.9 | 45 | 3.5 | 32 |
| Core 2 | 5.0 | 45 | 3.3 | 30 |

As shown in Table 5, DMS is quite effective for recovering an incremental quantity of oil from a formation core after recovery of oil from the core by waterflooding with a brine solution—recovering approximately 60% of the oil remaining in the core after the waterflood.

### Example 3

A polybutlyene polymer was mixed with DMS at two different polymer concentrations to examine the solubility of the polymer in DMS, the fluid characteristics of the polymer/DMS mixture at selected shear rate and temperature conditions, and the resultant viscosity of the polybutylene/DMS mixture at selected temperatures relative to DMS without polymer.

Two solutions of a polybutylene polymer in DMS were prepared by dissolving polybutylene in DMS. The first solution was prepared with 20.3 wt. % polybutylene and the second solution was prepared with 33.3 wt. % polybutylene. The polybutylene polymer used in preparing the solutions was a polybutylene polymer having an molecular weight number average (Mₙ) of approximately 2300, an average molecular weight (M_{w}) of approximately 129,000 g/mol, an isobutylene content of >90%, and a 1-butene content of 100%-isobutylene content %. In each solution, the polybutylene polymer was observed to dissolve completely in the DMS.

The polybutylene in DMS solutions generally displayed normal Newtonion fluid characteristics over a range of temperatures from 15° C. to 117° C. at shear rates ranging from 400 s⁻¹ to 2000 s⁻¹. A linear relationship between shear stress and shear rate was observed under most shear rate and temperature conditions examined for each of the solutions, where some deviation was observed at the highest temperatures and the highest shear rates.

The viscosity of each of the two polybutylene/DMS solutions was examined at 15° C., 39° C., 58° C., 78° C., 98° C., and 117° C. The measured viscosities of the solutions are shown in Table 6 below.

TABLE 6

| | Viscosity (mPa · s) | Viscosity (mPa · s) |
|---|---|---|
| Temperature | Solution 1 (20.3 wt % | Solution 2 (33.3 wt. % |
| (° C.) | polybutylene) | polybutylene) |
| 15 | 2.8 | 30.1 |
| 39 | 2.1 | 16.7 |
| 58 | 1.8 | 11.3 |
| 78 | 1.4-2.9 | 7.9 |
| 98 | 1.2-2.6 | 5.9 |
| 117 | 1.0-2.2 | 2.5-6.5 |

The viscosities of the polybutylene/DMS solutions are significantly increased relative to the viscosity of DMS alone, and increasing concentrations of polybutylene were observed to increase the viscosity of the polybutylene/DMS solutions. DMS itself has a viscosity of 0.29 mPa·s at 25° C. where the viscosity of DMS decreases as temperature increases. Mixing polybutylene with DMS, therefore, significantly increases the viscosity of the mixture relative to DMS, where polybutylene is miscible in the DMS and the polybutylene/DMS mixture generally displays Newtonian fluid characteristics over a temperature range of from 15° C. to 117° C. at a shear rate of from 400 s⁻¹ to 2000 s⁻¹.

### Example 4

A polystyrene polymer was mixed with DMS at two different polymer concentrations to examine the solubility of the polymer in DMS, the fluid characteristics of the polymer/DMS mixture at selected shear rate and temperature conditions, and the resultant viscosity of the polystyrene/DMS mixture at selected temperatures relative to DMS without polymer.

Two solutions of a polystyrene polymer in DMS were prepared by dissolving polystyrene in DMS. The first solution was prepared with 11.2 wt. % polystyrene and the second solution was prepared with 20.1 wt. % polystyrene. The polystyrene polymer used in preparing the solutions was a polystyrene polymer having an average molecular weight (M_{w}) of approximately 192,000 g/mol and a softening point of 107° C. as measured by ASTM Method D1525. In each solution, the polystyrene polymer was observed to dissolve completely in the DMS.

The polystyrene in DMS solutions generally displayed normal Newtonion fluid characteristics over a range of temperatures from 15° C. to 117° C. at shear rates ranging from

69 s⁻¹ to 2000 s⁻¹. A linear relationship between shear stress and shear rate was observed under most shear rate and temperature conditions examined for each of the solutions, where some deviation was observed at the highest temperatures and the highest shear rates.

The viscosity of each of the two polystyrene/DMS solutions was examined at 15° C., 39° C., 58° C., 78° C., 98° C., and 117° C. The measured viscosities of the solutions are shown in Table 7 below.

TABLE 7

| | Viscosity (mPa · s) | Viscosity (mPa · s) |
|---|---|---|
| Temperature | Solution 1 (11.2 wt % | Solution 2 (20.1 wt. % |
| (° C.) | polystyrene) | polystyrene) |
| 15 | 15 | 141-151 |
| 39 | 11 | 95-104 |
| 58 | 8.6 | 70-80 |
| 78 | 7.0 | 59-69 |
| 98 | 4.2 | 133-284 |
| 117 | 1-8 | 18-997 |

The viscosities of the polystyrene/DMS solutions are significantly increased relative to the viscosity of DMS alone, and increasing concentrations of polystyrene were observed to increase the relative viscosity of the polystyrene/DMS solutions. A large increase in viscosity of the 20.1 wt. % polystyrene/DMS solution was observed at higher temperatures, which is believed to be a result of bulk separation of the polymer from the solution. DMS itself has a viscosity of 0.29 mPa·s at 25° C. where the viscosity of DMS decreases as temperature increases. Mixing polystyrene with DMS, therefore, significantly increases the viscosity of the mixture relative to DMS, where polystyrene is miscible in the DMS (except as observed at the highest temperatures in the solution containing 20.1 wt. % polystyrene) and the polystyrene/DMS mixture generally displays Newtonian fluid characteristics over a temperature range of from 15° C. to 117° C. at a shear rate of from 69 s⁻¹ to 2000 s⁻¹.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. While systems and methods are described in terms of “comprising,” “containing,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from a to b,” or, equivalently, “from a-b”) disclosed herein is to be understood to set forth every number and range encompassed within the broader range of values. Whenever a numerical range having a specific lower limit only, a specific upper limit only, or a specific upper limit and a specific lower limit is disclosed, the range also includes any numerical value “about” the specified lower limit and/or the specified upper limit. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces.

What is claimed is:

1. A process for recovering oil from an oil-bearing formation comprising:
providing an oil recovery formulation that comprises a polymer dispersed in a fluid comprising at least 75 mol % dimethyl sulfide, wherein the polymer is a hydrocarbon polymer or a polymer consisting of carbon, hydrogen, and sulfur atoms, and wherein the oil recovery formulation has a dynamic viscosity of from 1 mPa·s (cP) to 5000 mPa·s (cP) at a temperature within a range of formation temperatures;
introducing the oil recovery formulation into the oil-bearing formation;
contacting the oil recovery formulation with oil in the formation; and
producing oil from the formation after contact of the oil recovery formulation with oil in the formation.

2. The process of claim 1 wherein the oil recovery formation has a mobility ratio in the formation relative to oil in the formation of from 0.5 to 5.

3. The process of claim 1 wherein the polymer of the oil recovery formulation is miscible in the fluid of the oil recovery formulation at a temperature of 25° C.

4. The process of claim 1 wherein the polymer of the oil recovery formulation is selected from the group consisting of polystyrene, polyisobutylene, liquid phase saturated hydrocarbon polymers, poly(p-phenylene sulfide), polybenzothiophene, and polythiophene.

5. The process of claim 1 wherein the hydrocarbon polymer is selected from the group consisting of polystyrene, polyisobutylene, a polymer comprised of at least 20 wt. % of a styrene monomer and a monomer selected from the group consisting of ethylene, propylene, and butylene, and a polymer comprised of at least 20 wt. % of an isobutylene monomer and a monomer selected from the group consisting of ethylene, propylene, and butylene.

6. The process of claim 1 wherein the oil recovery formulation contains from 250 ppmw to 20000 ppmw of the polymer.

7. The process of claim 1 wherein the oil recovery formulation is comprised of at least 95 mol % dimethyl sulfide.

8. The process of claim 1 wherein the oil-bearing formation is a subterranean formation.

9. The process of claim 8 wherein the subterranean formation is comprised of a material selected from the group consisting of a porous mineral matrix, a porous rock matrix, and a combination of a porous mineral matrix and a porous rock matrix.

10. The process of claim 9 wherein the porous mineral or rock matrix is a consolidated matrix comprising sandstone, limestone, or dolomite.

11. The process of claim 1 wherein the well through which the oil recovery formulation is introduced into the formation is a first well, and oil is produced from the formation via a second well extending into the formation.

12. The process of claim 1 wherein the oil recovery formulation in the liquid phase is first contact miscible with oil in, or from, the formation.

13. The process of claim 1 wherein the oil recovery formulation in liquid phase is first contact miscible with a liquid crude oil that comprises at least 25 wt. % hydrocarbons having a boiling point of at least 538° C. as measured by ASTM Method D7169.

14. The process of claim 1 wherein the oil recovery formulation in liquid phase is first contact miscible with a liquid crude oil that comprises less than 25 wt. % hydrocarbons having a boiling point of at least 538° C. as measured by ASTM Method D7169.

15. The process of claim 1 wherein the oil recovery formulation is produced from the formation with oil.

16. The process of claim 1 further comprising the step of introducing an oil immiscible formulation comprising water into the petroleum-bearing formation subsequent to introduction of the oil recovery formulation into the formation.

17. A system for producing oil from an oil-bearing formation, comprising:
an oil recovery formulation that comprises a polymer dispersed in a fluid comprising at least 75 mol % dimethyl sulfide, wherein the polymer is a hydrocarbon polymer or a polymer consisting of carbon, hydrogen, and sulfur atoms, and wherein the oil recovery formulation has a dynamic viscosity of from 1 mPa·s (cP) to 5000 mPa·s (cP) at a temperature within a range of formation temperatures;
a first well structured and arranged to introduce the oil recovery formulation into the oil-bearing formation; and
a second well located a distance from the first well, the second well being structured and arranged for producing oil from the oil-bearing formation subsequent to the introduction of the oil recovery formulation into the formation.

18. The system of claim 17 wherein the oil recovery formulation is first contact miscible with oil in, or from, the oil-bearing formation.

19. The system of claim 17 wherein the oil-bearing formation is a subterranean formation.

20. The system of claim 17 wherein the polymer of the oil recovery formulation is selected from the group consisting of polystyrene, polyisobutylene, liquid phase saturated hydrocarbon polymers, poly(p-phenylene sulfide), polybenzothiophene, and polythiophene.

21. The system of claim 17 wherein the hydrocarbon polymer is selected from the group consisting of polystyrene, polyisobutylene, a polymer comprised of at least 20 wt. % of a styrene monomer and a monomer selected from the group consisting of ethylene, propylene, and butylene, and a polymer comprised of at least 20 wt. % of an isobutylene monomer and a monomer selected from the group consisting of ethylene, propylene, and butylene.

22. The system of claim 17 further comprising:
an oil immiscible formulation comprising water; and
a mechanism for injecting the oil immiscible formulation into the petroleum-bearing formation.

23. A composition for use in oil recovery from an oil-bearing formation, comprising:
a fluid comprising at least 75 mol % dimethyl sulfide; and
a polymer dispersed in the fluid, wherein the polymer is selected from a hydrocarbon polymer or a polymer consisting of carbon, hydrogen, and sulfur atoms.

24. The composition of claim 23 wherein the fluid is comprised of at least 95 mol % dimethyl sulfide.

25. The composition of claim 23 wherein the polymer is selected from the group consisting of polystyrene, polyisobutylene, liquid phase saturated hydrocarbon polymers, poly(p-phenylene sulfide), polybenzothiophene, and polythiophene.

26. The composition of claim 23 wherein the hydrocarbon polymer is selected from the group consisting of polystyrene, polyisobutylene, a polymer comprised of at least 20 wt. % of a styrene monomer and a monomer selected from the group consisting of ethylene, propylene, and butylene, and a polymer comprised of at least 20 wt. % of an isobutylene monomer and a monomer selected from the group consisting of ethylene, propylene, and butylene.

27. The composition of claim 23 containing from 250 ppmw to 250000 ppmw of the polymer.

28. The composition of claim 23 having a dynamic viscosity of from 1 mPa·s to 1000 mPa·s at 25° C.

29. The composition of claim 23 having a dynamic viscosity of from 1 mPa·s to 1000 mPa·s at 75° C.

30. The composition of claim 23 having a dynamic viscosity of from 1 mPa·s to 1000 mPa·s at 125° C.

31. The composition of claim 23 wherein the polymer is miscible with the fluid.
